(19) United States
(12) Patent Application Publication
(10) Pub. No.: US 2020/0376633 A1
(43) Pub. Date: Dec. 3, 2020

(54) NUTRUNNER AND SCREW TIGHTENING METHOD

(71) Applicant: SANYO MACHINE WORKS, LTD., Aichi (JP)

(72) Inventors: Hisashi RYOTA, Aichi (JP); Kotaro URATA, Aichi (JP)

(21) Appl. No.: 16/789,750

(22) Filed: Feb. 13, 2020

(30) Foreign Application Priority Data
Jun. 3, 2019 (JP) 2019-103610

(51) Int. Cl. B25B 21/00; B23P 19/10; B23P 19/06

(52) U.S. Cl. CPC B25B 21/002; B25B 23/147; B23P 19/06; B23P 19/107

(57) ABSTRACT

A nutrunner includes a motor, an angle sensor, a vibration sensor, and a control unit (controller) that drives and controls the motor. While male and female screws are pressed against each other in an axial direction, the motor is rotated in a reverse direction to a screw tightening direction, and impact forces generated at that time from a periodic collision between threaded openings are detected by the vibration sensor. When the vibration sensor detects the impact force at least two consecutive times, and a difference angle between a rotation angle of the angle sensor at a first detection and a rotation angle of the angle sensor at a second detection coincides with a theoretical angle period of the periodic collision, the motor is switched to a forward rotation.

### BACKGROUND OF THE INVENTION

### (1) Field of the Invention

The present invention relates to a nutrunner and a screw tightening method, and particularly to a nutrunner and a screw tightening method that prevent screw bites when a bolt or nut is automatically tightened to a workpiece.

### (2) Description of Related Art

A nutrunner is used to automatically tighten a bolt or nut to a workpiece. That is, a nutrunner is used to tighten a bolt into a screw hole of a workpiece, or tighten a nut to a stud bolt projecting from the workpiece. When axial lines of the screws are not in a straight line at the time of this screw tightening, there is a risk that the screw bites occur.

Therefore, in an invention of JP 2006-315097 A, a bolt or nut is rotated forward upon detection of an impact force due to a collision between threaded openings which is caused by rotating the bolt or nut reversely a plurality of times. In an invention of JP 2017-170574 A, a bolt or nut is rotated forward when a time interval of a collision between threaded openings caused during a reverse rotation of the bolt or nut coincides with a theoretical period of the collision. The invention of JP 2017-170574 A is an improved invention of JP 2006-315097 A, and prevents the nutrunner from malfunctioning by distinguishing the impact force caused by the collision between threaded openings from other impact noises.

However, in the invention of JP 2017-170574 A, an acceleration of the nutrunner from a start of the reverse rotation of the bolt or nut and a reverse rotation speed of the nutrunner may change during the rotation due to a load or the like of the nutrunner. With such a change in the rotation speed, the measured time interval of the collision between the threaded openings will not coincide with the theoretical period of the collision. This may lead to a malfunction of missing a timing of switching to the forward rotation, and a delay in the tightening operation of the nutrunner, or the unnecessarily prolonged reverse rotation may cause the threaded openings to be crushed.

### SUMMARY OF THE INVENTION

It is an object of the present invention to provide a nutrunner and a screw tightening method capable of reliably starting a tightening operation without a malfunction even when an acceleration of the nutrunner from a start of the reverse rotation of the bolt or nut changes during the rotation or when a reverse rotation speed of the nutrunner changes during the rotation.

In order to solve the above-mentioned problems, the nutrunner of the present invention includes a motor that rotates a male screw or a female screw, an angle sensor that detects a rotation angle of the motor, a vibration sensor that detects an impact force generated from a periodic collision between a threaded opening of the male screw and a threaded opening of the female screw when the motor is rotated in a reverse direction to a screw tightening direction with the male and female screws pressed against each other in an axial direction, and a control unit that drives and controls the motor. The control unit reversely rotates the motor before a screw tightening of the male and female screws starts, and switches the motor to a forward rotation when the vibration sensor detects the impact force at least two consecutive times and a difference angle θ2−θ1 between a rotation angle θ1 of the angle sensor at a first detection and a rotation angle θ2 of the angle sensor at a second detection coincides with a theoretical angle period of the periodic collision.

A screw tightening method according to the present invention is a method of tightening a screw with a nutrunner. The method includes rotating the nutrunner in a reverse direction to a screw tightening direction with a male screw and a female screw pressed against each other in an axial direction, detecting, with a vibration sensor, an impact force generated from a periodic collision, caused by the reverse rotation, between a threaded opening of the male screw and a threaded opening of the female screw, and switching the nutrunner to a forward rotation when the vibration sensor detects the impact force at least two consecutive times and a difference angle θ2−θ1 between a rotation angle θ1 of the nutrunner at a first detection and a rotation angle θ2 of the nutrunner at a second detection coincides with a theoretical angle period of the periodic collision.

According to the present invention, the tightening operation can reliably start without a malfunction even when an acceleration of the nutrunner from a start of the reverse rotation of the bolt or nut changes during the rotation or when a reverse rotation speed of the nutrunner changes during the rotation.

### BRIEF DESCRIPTION OF THE DRAWINGS

FIG. 1 is a schematic diagram of a nutrunner according to an embodiment of the present invention;

FIG. 2A is a diagram showing a bolt rotated reversely with the nutrunner;

FIG. 2B is a diagram showing the bolt rotated reversely with the nutrunner;

FIG. 2C is a diagram showing the bolt rotated forward with the nutrunner;

FIG. 3 is a time chart showing the bolt switched from a reverse rotation to a forward rotation; and

FIG. 4 is a flowchart showing an operation of a controller.

### DETAILED DESCRIPTION OF PREFERRED EMBODIMENTS

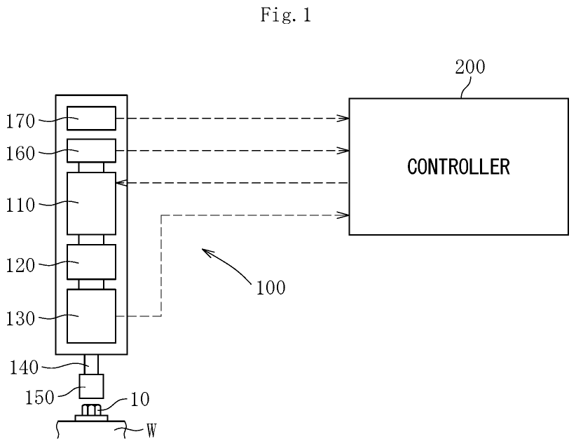

Hereinafter, a nutrunner and a screw tightening method according to an embodiment of the present invention will be described with reference to the drawings. FIG. 1 shows a nutrunner 100 and a controller 200 as a control unit for the nutrunner 100. The nutrunner 100 includes a motor 110, a reduction gear 120, an output shaft 140, a socket 150, an angle sensor 160, and a vibration sensor 170.

The angle sensor 160 detects a rotation angle of the output shaft 140, and can be configured by an absolute rotary encoder or an incremental rotary encoder. The vibration sensor 170 detects an impact force acting on the output shaft 140, particularly an impact force in the axial direction of the output shaft 140, and a known accelerometer, speedometer, or the like can be used therefor. The vibration sensor 170 has at least one sensitivity axis, and the sensitivity axis is attached in accordance with the axial direction of the output shaft 140.

The motor 110 is driven and controlled by the controller 200. In addition to the motor 110, the controller 200 is connected to a torque sensor 130, the angle sensor 160, and the vibration sensor 170. The torque, rotation angle, and impact force of the output shaft 140 detected by these sensors are input to the controller 200.

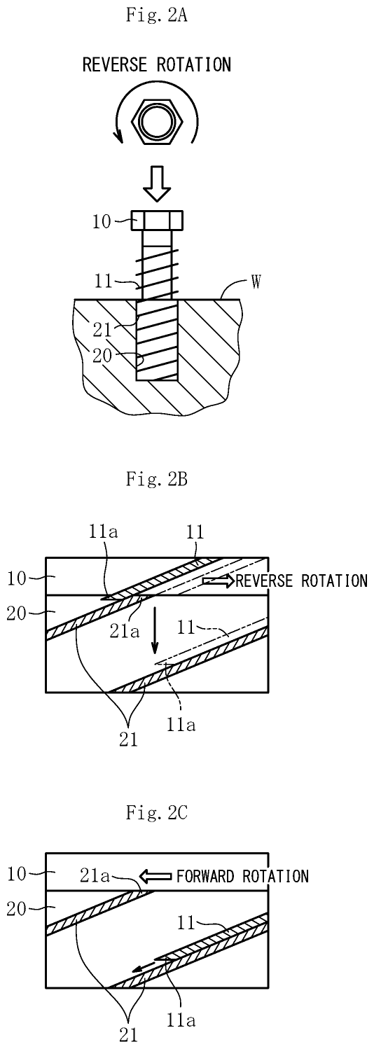

FIGS. 2A and 2B show a collision between threaded openings that has occurred at the time of a reverse rotation of a bolt 10 with a tip of the bolt 10, in which a male screw is cut, pressed against an inlet of a screw hole 20 of a workpiece W in which a female screw is cut. FIG. 2C shows a direction in which an opening 11a of a thread 11 moves when the bolt 10 is rotated forward to start the screw tightening. FIGS. 2B and 2C each shows a circumferential direction of the screw in an expansion plan.

Here, a “threaded opening” means a thread end of a male screw and a female screw. As shown in FIG. 2A, while the tip of the bolt 10 is pressed against the inlet of the screw hole 20 of the workpiece W, the bolt 10 is rotated reversely with the nutrunner 100.

The bolt 10 is reversely rotated, and the thread 11 at the tip of the bolt 10 moves in the direction of the arrow as shown in FIG. 2B and passes an opening 21a of a thread 21 at the inlet of the screw hole 20. Then, the thread 11 of the bolt 10 falls by one pitch and collides with the thread 21 below. This collision causes an impact force to be transmitted to the output shaft 140 of the nutrunner 100, and the magnitude of the impact force is detected by the vibration sensor 170. The detected impact force is input to the controller 200 together with the rotation angle of the output shaft 140 at that time.

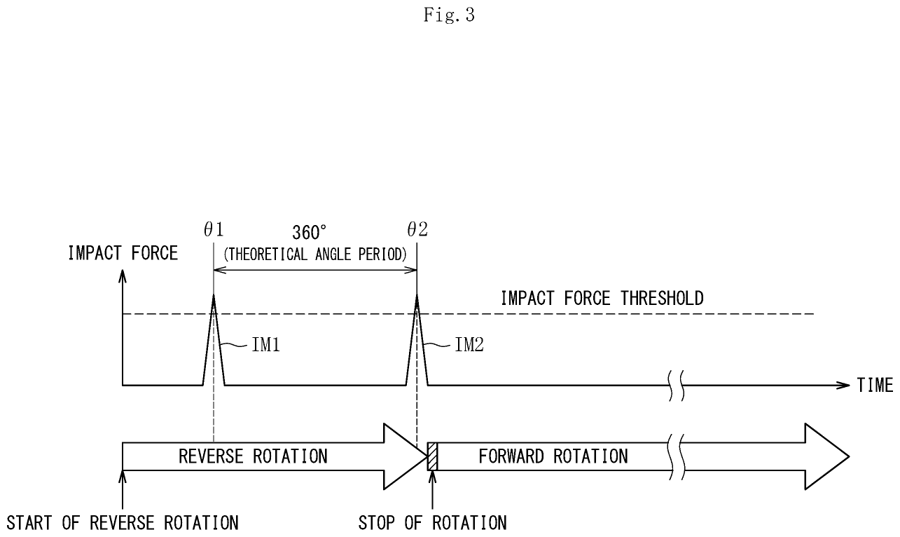

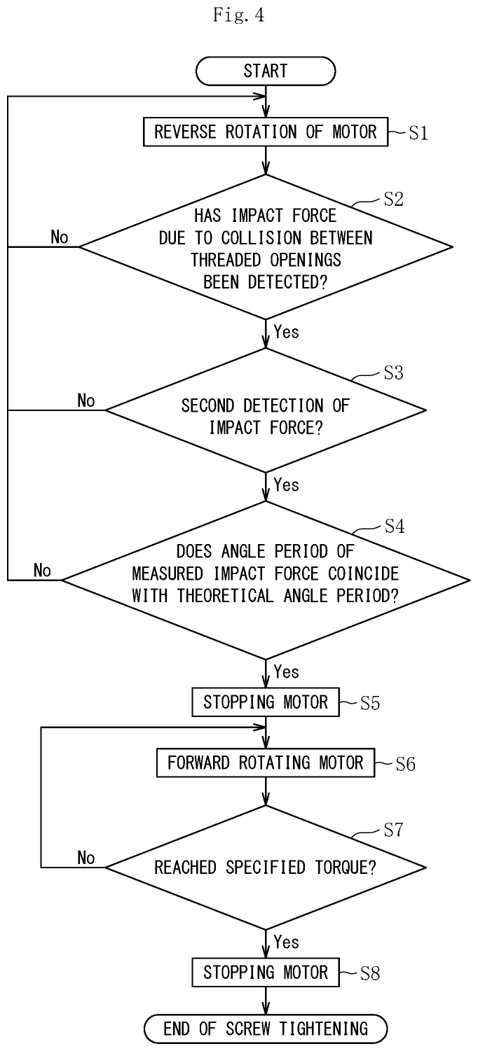

FIG. 3 is a time chart showing a change from the reverse rotation to the forward rotation of the motor 110 of the nutrunner 100 based on the detection of the impact force. A determination of whether the reverse rotation of the motor 110 is continued or switched to the forward rotation depends on whether a difference angle (θ2−θ1) between a rotation angle θ1 and a rotation angle θ2 is 360° (see step S3 in the flowchart of FIG. 4 described below). The rotation angle θ1 is a rotation angle at a first detection of an impact force IM1 greater than or equal to a predetermined threshold after the start of the reverse rotation of the motor 110. The rotation angle θ2 is a rotation angle at a second detection of an impact force IM2 greater than or equal to the predetermined threshold. FIG. 3 shows a change to the forward rotation where the difference angle (θ2−θ1)=360°. A short rotation stop period is provided between the reverse rotation and the forward rotation.

The “predetermined threshold” can be set to a predetermined value within a range of, for example, 70% to 90% of the measured maximum impact force. As the threshold is larger, malfunctions due to other impact noises can be more readily reduced. However, when the threshold is too large, the tightening operation may be delayed for a lack of detection of an impact force. Therefore, the “predetermined threshold” may be set to an optimum value based on the magnitude of the impact force measured a plurality of times for each type of bolt 10.

In theory, the difference angle (θ2−θ1) is to be 360°. However, in practice, the difference angle (θ2−θ1) varies depending on the detection accuracy of the angle sensor 160 and the vibration sensor 170 as well as the component accuracy of the bolt 10. Thus, for example, an allowable angle error of about ±5° can be set. In a case where the allowable angle error of ±5° is set, the reverse rotation is switched to the forward rotation at 355°≤ difference angle (θ2−θ1)≤365°.

The pressing force of the bolt 10 for the reverse rotation of the motor 110 may be the same as the pressing force of the bolt 10 for the subsequent forward rotation of the motor 110. By maintaining the pressing force constant, as described above, the impact forces IM1 and IM2 are reliably generated and the speed of the tightening operation of the bolt 10 is increased.

Further, a rotation speed when the motor 110 is reversely rotated may be the same as or lower than the rotation speed when the motor 110 is rotated forward. This suppresses the generation of the impact noises and enhances the determination precision of an angle period described below.

Next, an operation of the controller 200 will be described with reference to the flowchart of FIG. 4. In tightening the bolt 10 into the screw hole 20 of the workpiece W shown in FIG. 2A with the nutrunner 100 shown in FIG. 1, the bolt 10 is first rotated in step S1 in a reverse direction to a direction in which the bolt 10 is tightened.

The reverse rotation of the bolt 10, as shown in FIG. 2B, causes the opening 11a of the thread 11 of the bolt 10 to periodically collide with the opening 21a of the thread 21 of the female screw. In step S2, it is determined whether an impact force due to the periodic collision has been detected by the vibration sensor 170.

When the magnitude of the impact force is greater than the predetermined threshold, it is determined that the impact force is due to the periodic collision between the threaded openings. When it is not determined in step S2 that the impact force has been detected by the vibration sensor 170, the processing returns to step S1, and the reverse rotation of the motor 110 continues.

When it is determined in step S2 that the impact force has been detected by the vibration sensor 170, the processing proceeds to next step S3, and it is determined whether the impact force has been detected for the second time. When it is determined that the impact force has been detected for the second time, the processing proceeds to next step S4, and it is determined whether the angle period of the measured impact force coincides with the theoretical angle period (360°).

When the angle periods do not coincide with each other, the impact force detected by the vibration sensor 170 for the first or second time is likely to be other than the impact force due to the collision of the threaded openings. Thus, the impact force detection count is set to “0”. Subsequently, the processing returns to step S1, the reverse rotation of the motor 110 continues, and the determinations of steps S2 to S4 are repeated.

When it is determined in step S4 that the angle periods coincide with each other, the motor 110 is stopped in step S5, and then the motor 110 is rotated forward in step S6 in the tightening direction. Next, in step S7, it is determined by a signal from the torque sensor 130 whether the tightening torque of the nutrunner 100 has reached the specific torque.

In a case where the tightening torque of the nutrunner 100 has not reached the specific torque, the processing returns to step S6, and the forward rotation of the motor 110 continues. When the tightening torque of the nutrunner 100 reaches the specific torque, the motor 110 is stopped in step S8, and then the screw tightening with the nutrunner 100 ends.

Although the embodiment of the present invention has been described, the present invention is not limited to the embodiment, and permits various modifications. For example, in the above embodiment, assuming that the thread of the bolt 10 is a single-threaded screw, the theoretical angle period is 360°. However, when the thread of the bolt 10 is a double-threaded screw, the theoretical angle period may be 180°.

In the above embodiment, it is determined whether the angle periods coincide with each other by the first and second detections of the impact forces IM1 and IM2. However, it may be determined whether the angle periods coincide with each other by three or more times of detections of the impact forces to improve the determination precision. In this case, to prevent the threaded opening from being crushed by the pressing force of the bolt 10, the pressing force of the bolt 10 at the reverse rotation of the motor 110 may be smaller than the pressing force of the bolt 10 at the subsequent forward rotation of the motor 110.

1. A nutrunner comprising:
a motor that rotates a male screw or a female screw;
an angle sensor that detects a rotation angle of the motor;
a vibration sensor that detects an impact force generated from a periodic collision between a threaded opening of the male screw and a threaded opening of the female screw when the motor is rotated in a reverse direction to a screw tightening direction with the male and female screws pressed against each other in an axial direction; and
a control unit that drives and controls the motor,
wherein the control unit reversely rotates the motor before a screw tightening of the male and female screws starts, and switches the motor to a forward rotation when the vibration sensor detects the impact force at least two consecutive times and a difference angle θ2−θ1 between a rotation angle θ1 of the angle sensor at a first detection and a rotation angle θ2 of the angle sensor at a second detection coincides with a theoretical angle period of the periodic collision.

2. The nutrunner according to claim 1, wherein the theoretical angle period is 360° when the male and female screws are single-threaded screws.

3. The nutrunner according to claim 1, wherein the theoretical angle period is 180° when the male and female screws are double-threaded screws.

4. The nutrunner according to claim 1, wherein the motor is reversely rotated at a lower rotation speed than a rotation speed when the motor is rotated forward.

5. A screw tightening method being a method of tightening a screw with a nutrunner, the method comprising:
rotating the nutrunner in a reverse direction to a screw tightening direction with male and female screws pressed against each other in an axial direction;
detecting, with a vibration sensor, an impact force generated from a periodic collision, caused by the reverse rotation, between threaded openings of the male and female screws; and
switching the nutrunner to a forward rotation when the vibration sensor detects the impact force at least two consecutive times and a difference angle θ2−θ1 between a rotation angle θ1 of the nutrunner at a first detection and a rotation angle θ2 of the nutrunner at a second detection coincides with a theoretical angle period of the periodic collision.

6. The screw tightening method according to claim 5, wherein a pressing force of the male and female screws when the nutrunner is reversely rotated is smaller than a pressing force when the nutrunner is rotated forward.

7. The screw tightening method according to claim 5, wherein a rotation speed when the nutrunner is reversely rotated is lower than a rotation speed when the nutrunner is rotated forward.

8. The screw tightening method according to claim 6, wherein a rotation speed when the nutrunner is reversely rotated is lower than a rotation speed when the nutrunner is rotated forward.
